(19) United States
(12) Patent Application Publication
(10) Pub. No.: US 2011/0183674 A1
(43) Pub. Date: Jul. 28, 2011

(54) TERMINAL AND METHOD FOR HANDOVER THEREOF

(76) Inventors: Hyun Lee, Dajeon (KR); Sung Cheol Chang, Dajeon (KR); Kwang Jae Lim, Dajeon (KR); Chul Sik Yoon, Seoul (KR); Namgi Kim, Gyeonggi-do (KR)

(21) Appl. No.: 13/062,632

(22) PCT Filed: Sep. 1, 2009
(86) PCT No.: PCT/KR2009/004900

§ 371 Date: Mar. 7, 2011

(30) Foreign Application Priority Data
Sep. 5, 2008 (KR) 10-2008-0087912
Jan. 12, 2009 (KR) 10-2009-002332
Aug. 17, 2009 (KR) 10-2009-0075789

(51) Int. Cl. H04W 36/00

(52) U.S. Cl. 455/436

(57) ABSTRACT

A method for handover of the present invention is a method for handover of a terminal supporting a multi-carrier including a first carrier and a second carrier, the method including: transmitting a handover request message to a serving base station; receiving a handover response message from the serving base station according to a handover response message transmitted from a target base station to the serving base station; after receiving the handover response message from the serving base station, transmitting and receiving data to and from the serving base station using the first carrier; and performing a handover signaling process to the target base station using the second carrier.

### TECHNICAL FIELD

The present invention relates to a terminal and a method for handover thereof.

### BACKGROUND ART

When a terminal moves from a cell managed by one base station to a cell managed by another base station, the terminal performs a handover process. The base station to which the terminal is originally connected is called a serving base station, and the base station to which the terminal is subsequently connected is called a target base station.

A handover interruption time during which the terminal does not transmit and receive data may occur during the handover process. However, in order to provide a high-quality communication service, it is important to minimize the handover interruption time.

The above information disclosed in this Background section is only for enhancement of understanding of the background of the invention and therefore it may contain information that does not form the prior art that is already known in this country to a person of ordinary skill in the art.

### DISCLOSURE OF INVENTION

### Technical Problem

The present invention has been made in an effort to perform a handover process using a multi-carrier to remove a handover interruption time that may be caused during the handover process.

### Solution to Problem

An exemplary embodiment of the present invention provides a method for handover of a terminal supporting a multi-carrier including a first carrier and a second carrier, including: transmitting a handover request message to a serving base station; receiving a handover response message from the serving base station according to a handover response message transmitted from a target base station to the serving base station; after receiving the handover response message from the serving base station, transmitting and receiving data to and from the serving base station using the first carrier; and performing a handover signaling process to the target base station using the second carrier.

The first carrier may be a secondary carrier, and the second carrier may be a primary carrier.

The transmitting a handover request message to a serving base station may be performed using the primary carrier.

The first carrier may be a secondary carrier and the second carrier may be a primary carrier.

The transmitting a handover request message to a serving base station may be performed using the primary carrier.

The method for handover may further include receiving a handover completion message from the target base station.

The transmitting and receiving the data to and from the serving base station using the first carrier may be terminated when the terminal receives the handover completion message.

The transmitting and receiving the data to and from the serving base station using the first carrier may be terminated when the terminal receives a carrier disconnection message transmitted from the target base station to the serving base station.

The performing the handover signaling process includes transmitting a handover ranging code to the target base station, transmitting a ranging request message to the target base station, receiving a ranging response message from the target base station, and transmitting a bandwidth request message to the target base station.

The communication using the first carrier between the terminal and the serving base station may be terminated by receiving the bandwidth request message.

After transmitting the ranging request message, the serving base station may receive the carrier disconnection message from the target base station prior to receiving the ranging response message, and the transmitting and receiving the data to and from the serving base station using the first carrier may be terminated when the terminal receives the ranging response message.

The communication using the first carrier between the terminal and the serving base station may be terminated by transmitting the ranging request message.

Yet another exemplary embodiment of the present invention provides a terminal comprising; a first frequency channel module supporting a first carrier; a second frequency channel module supporting a second carrier; a handover controller that performs a handover signaling process to a target base station using the first carrier; and a data communication unit that transmits/receives data to and from the serving base station using the second carrier while the handover signaling process is performed.

Either one of the first carrier and the second carrier may be a primary carrier, and the other may be a secondary carrier.

The handover controller may transmit and receive messages, which query whether the handover can be performed, with the serving base station using the primary carrier.

### Advantageous Effects of Invention

The present invention removes the handover interruption time that may occur during the handover process of the terminal, thereby making it possible to provide a high-quality communication service.

### BRIEF DESCRIPTION OF DRAWINGS

FIG. 1 is a diagram showing a wireless communication system according to an exemplary embodiment of the present invention;

FIG. 2 is a diagram showing a wireless communication system according to another embodiment of the present invention;

FIG. 3 is a flowchart schematically showing a handover process according to an exemplary embodiment of the present invention;

FIG. 4 is a flowchart showing a method for handover according to an exemplary embodiment of the present invention;

FIG. 5 is a flowchart showing a method for handover according to another embodiment of the present invention;

FIG. 6 is a flowchart showing a method for handover according to another embodiment of the present invention;

FIG. 7 is a flowchart showing a method for handover according to another embodiment of the present invention;

FIG. 8 is a flowchart showing a method for handover according to another embodiment of the present invention;

FIG. 9 is a flowchart showing a method for handover according to another embodiment of the present invention; and

FIG. 10 is a block diagram schematically showing a terminal according to another embodiment of the present invention.

### MODE FOR THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive, Like reference numerals designate like elements throughout the specification.

In the specification, unless explicitly described to the contrary, the word “comprise” and variations such as “comprises” or “comprising” will be understood to imply the inclusion of stated elements but not the exclusion of any other elements.

In the specification, a terminal may designate a mobile station (MS), a mobile terminal (MT), a subscriber station (SS), a portable subscriber station (PSS), user equipment (UE), an access terminal (AT), etc., and may include the entire or partial functions of the terminal, the mobile terminal, the subscriber station, the portable subscriber station, the user equipment, the access terminal, etc.

In the specification, a base station (BS) may designate an access point (AP), a radio access station (RAS), a node B, an evolved node B (eNodeB), a base transceiver station (BTS), a mobile multihop relay (MMR)-BS, etc., and may include the entire or partial functions of the access point, the radio access station, the node B, the evolved node B, the base transceiver station, the MMR-BS, etc.

Hereinafter, a terminal and a method for handover thereof according to an exemplary embodiment of the present invention will be described in detail with reference to the accompanying drawings.

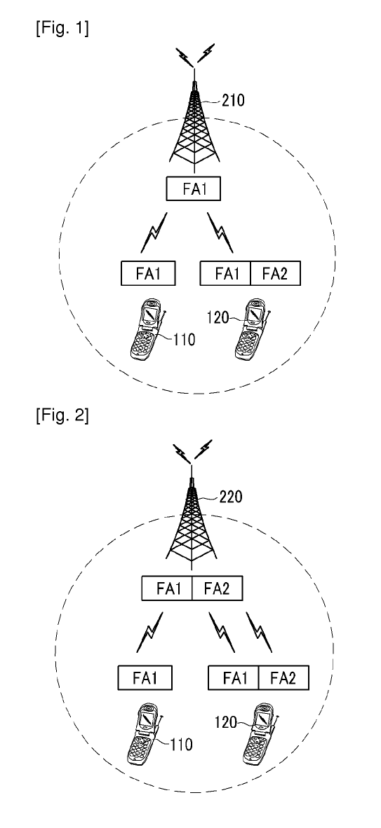

FIG. 1 is a diagram showing a wireless communication system according to an exemplary embodiment of the present invention, and FIG. 2 is a diagram showing a wireless communication system according to another embodiment of the present invention.

Referring to FIG. 1, the wireless communication system includes terminals 110 and 120 and a base station 210.

The terminals 110 and 120, which are ending points of a wireless channel, are connected to the base station 210 to transmit and receive data.

The terminal 110 supports one carrier having a frequency band FA1, and the terminal 120 supports two carriers of which each has the frequency band FA1 and a frequency band FA2.

The base station 210 receives data from the terminals 110 and 120 and transmits data to the terminals 110 and 120.

The base station 210 supports one carrier having the frequency band FA1.

The terminals 110 and 120 communicate with the base station 210 using the carrier having the frequency band FA1.

The wireless communication system of FIG. 2 also includes the terminals 110 and 120 and the base station 220.

However, unlike the wireless communication system of FIG. 1, the base station 220 supports two carriers each of which has the frequency band FA1 and the frequency band FA2.

The terminal 110 communicates with the base station 220 using the carrier having the frequency band FA1, and the terminal 120 communicates with the base station 220 using two carriers each of which has the frequency band FA1 and the frequency band FA2.

In a terminal 120 using two carriers or more, that is, a multi-carrier, the carrier is classified into two sorts, one being a primary carrier and the other being a secondary carrier.

The primary carrier is a carrier to transmit and receive various control information and data between the base station and the terminal, and the terminal 120 uses one of several carriers as the primary carrier in an area of one base station 220.

The secondary carrier is an additional carrier used only for transmission and reception of data in a state where the terminal transmits and receives control information through the primary carrier.

However, the control information for operating the multi-carrier can be transmitted and received through the secondary carrier.

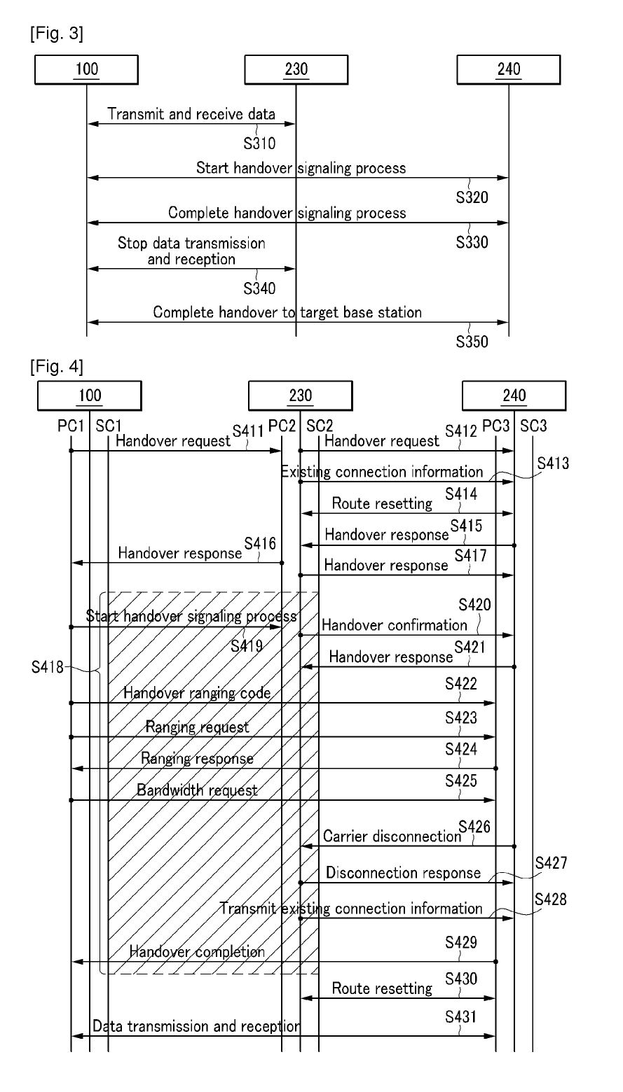

A method for handover according to an exemplary embodiment of the present invention will be described below in detail with reference to FIG. 3.

FIG. 3 is a flowchart schematically showing a handover process according to an exemplary embodiment of the present.

Referring to FIG. 3, the terminal 100 transmits and receives data to and from a serving base station 230 (S310).

Then, the terminal 100 starts a handover signaling process to a target base station 240 while transmitting and receiving data to and from the serving base station 230 (S320).

The terminal 10 subsequently completes the handover signaling process to the target base station 240 (S330).

The terminal 100 then stops the data transmission and reception to and from the serving base station 230 (S340) and completes the handover to the target base station 240 (S350).

In order for the terminal 100 to perform the handover process to the target base station 240 while transmitting and receiving data to and from the serving base station 230, the terminal 100 uses the multi-carrier.

Hereinafter, several embodiments of the method for handover shown in FIG. 3 will be described in detail.

FIG. 4 is a flowchart showing a method for handover according to an exemplary embodiment of the present invention.

Referring to FIG. 4, the terminal 100 supports multi-carriers PC1 and SC1, and the PC1 of them is used as the primary carrier and the SC1 is used as the secondary carrier.

Each of the serving base station 230 and the target base station 240 also supports carriers PC2 and PC3 used as the primary carrier and supports carriers SC2 and SC3 used as the secondary carrier.

First, the terminal 100 requests handover from the serving base station 230 using the primary carrier PC1 (S411).

The handover request (S411) is transmitted through a mobility mobile station handover request (MOB_MSHO_REQ) message.

At this time, the terminal 100 can query the serving base station 230 whether or not the handover can be performed using the multi-carrier, and the query is transmitted through a multicarrier handover enable/disable (MCHO En/Disable) field included in the MOB_MSHO_REQ message.

Then, the serving base station 230 transmits the handover request to the target base station 240 (S412).

The handover request S412 is transmitted through a handover request (HO-Request) message.

At this time, the serving base station 230 can query the target base station 240 whether or not the handover can be performed using the multi-carrier, and the query is transmitted through a multicarrier handover enable/disable (MCHO En/Disable) field included in the HO_Request message.

The serving base station 230 transmits existing connection information with the terminal 100 to the target base station 240 (S413), and the serving base station 230 and the target base station 240 optimize a route and then reset it (S414).

Then, the target base station 240 transmits a handover response to the serving base station 230 (S415).

The handover response S415 is transmitted through the HO-Response message, and the HO-Response message includes the MCHO En/Disable field that the target base station 240 responds to the serving base station 230 whether or not the handover using the multi-carrier can be performed.

The serving base station 230 transmits the handover response to the terminal 100 (S416).

The handover request (S416) is transmitted through the mobility mobile station handover request (MOB_MSHO_REQ) message.

The MOB_BSHO_REQ message includes the MCHO En/Disable field that the serving base station 230 responds to the terminal 100 whether the handover using the multi-carrier can be performed.

Also, the serving base station 230 transmits the handover response to the target base station 240 through a handover acknowledge (HO-Ack) message (S417).

When the terminal 100 receives a response that the handover can be performed using the multi-carrier from the serving base station 230, the terminal 100 transmits and receives to and from the serving base station 230 only by using the secondary carrier SC1 from this time (S418).

Then, the terminal 100 transmits a mobility handover indication (MOB_HO_IND) message to the serving base station 230 using the primary carrier PC1 to start the handover signaling process (S419).

The serving base station 230 receives the MOB_HO_IND message from the terminal 100 and then transmits handover confirmation through a HO-confirm message (S420).

Then, the target base station 240 transmits the handover response to the server base station 230 through the handover acknowledge (HO-Ack) message (S421).

The terminal 100 then performs the handover signaling process to the target base station 240 using the primary carrier PC1.

First, the terminal 100 transmits a handover ranging code to the target base station 240 using an HO ranging code message (S422) and requests the handover ranging using the ranging request (RNG_REQ) (S423).

Then, the target base station 240 transmits the handover ranging response to the terminal 100 using the RNG_RSP message (S424).

Then, the terminal 100 requests a bandwidth request to the target base station 240 through a bandwidth request (BW_REQ) message (S425).

The terminal 100 transmits the BW_REQ message to the target base station 240 to terminate the communication between the terminal 100 using the primary carrier PC1 and the serving base station 230.

After the target base station 240 receives the BW_REQ message from the terminal 100, the terminal 100 and the target base station 240 can transmit and receive the data or the control signal using the primary carrier PC1.

The target base station 240 informs the serving base station 230 using a handover disconnect secondary carrier (HD-Disconnect-SC) message that the disconnection of the secondary carrier SC1 used between the terminal 100 and the serving base station 230 is allowed (S426).

After the serving base station 230 receives the HO-Disconnect-SC message, it transmits the disconnection response that the secondary carrier SC1 used to transmit and receive data to and from the terminal 100 is no longer used to the target base station 240 (S427).

Then, the serving base station 230 transmits the existing connection information with the terminal 100 to the target base station 240 (S428).

The target base station 240 informs the terminal 100 using a MOB_MCHO_COMPLETE message that the handover process is completed (S429).

The transmitting and receiving the data using the secondary carrier SC1 between the terminal 100 and the serving base station 230 (S418) is completely terminated when the terminal 100 receives the MOB_MCHO_COMPLETE message.

The serving base station 230 and the target base station 240 optimize the route and reset it (S429).

After receiving the MOB_MCHO_COMPLETE message, the terminal 100 completes the handover process to the target base station 240 to transmit and receive the data to and from the target base station 240 (S430).

The method for handover according to an exemplary embodiment of the present invention performs the handover process to the target base station 240 using the primary carrier PC1, and performs the data transmission and reception to and from the serving base station 230 using the secondary carrier SC1 during the handover process when the terminal 100 is handed over from the serving base station 230 to the target base station 240.

Therefore, the handover interruption time during which the terminal does not transmit and receive the data during the handover process can be removed.

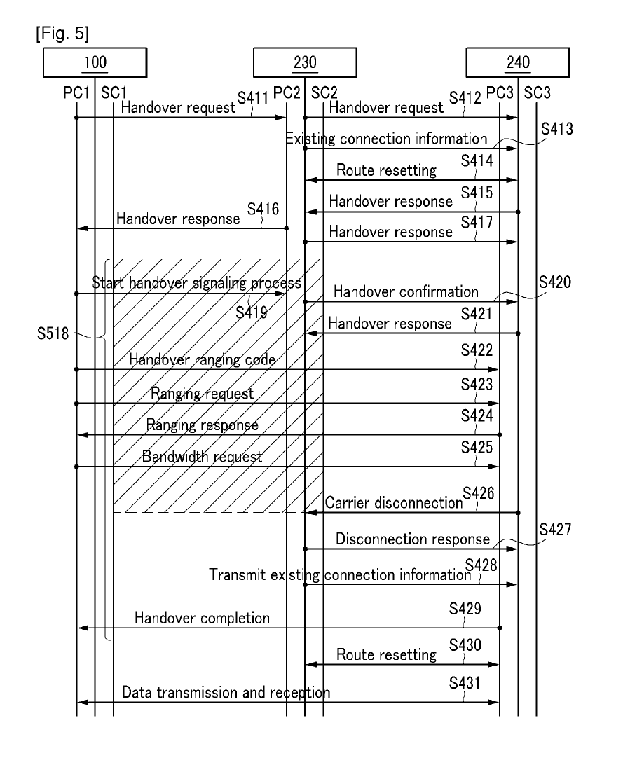

Hereinafter, a method for handover according to another of the present invention will be described in detail with reference to FIG. 5.

FIG. 5 is a flowchart showing a method for handover according to another embodiment of the present invention.

The method for handover of FIG. 5 performs a process similar to the method for handover of FIG. 4. However, unlike the handover method of FIG. 4, in the method for handover of FIG. 5, the transmitting and receiving the data by the serving base station 230 using only the secondary carrier SC1 (S518) is terminated by the HO-Disconnect-SC message for carrier disconnection (S426) and not the MOB_MCHO_COMPLETE message.

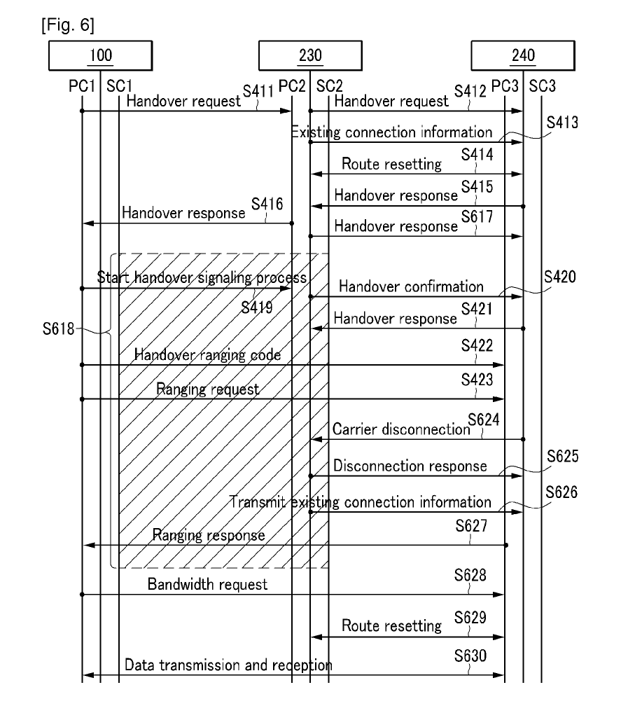

Hereinafter, the method for handover according to another embodiment of the present invention will be described in detail with reference to FIG. 6.

FIG. 6 is a flowchart showing a method for handover according to another embodiment of the present invention.

In the method for handover of FIG. 6, the steps from the handover request (S411) to the serving base station 230 of the terminal 100 to the ranging request using the ranging request (RNG_REQ) message to the target base station 240 of the terminal 100 (S423) are the same as the method for handover of FIG. 4. However, unlike the method for handover of FIG. 4, in the method for handover of FIG. 6, the connection of the terminal 100 using the primary carrier PCI and the serving base station 230 is interrupted after the terminal 100 transmits the ranging request (RNG_REQ) message for the ranging request.

Further, in the method for handover of FIG. 6, after the target base station 240 receives the ranging request (S423) from the terminal 100, the target base station 240 informs the serving base station 230 using the HO-Disconnect-SC message that the connection of the secondary carrier SC1 used between the terminal 100 and the serving base station 230 is interrupted (S624)

The serving base station 230 transmits the disconnection response that the secondary carrier SC1 used for transmitting and receiving data to and from the terminal 100 using the HO-Ack message after receiving the HO-Disconnect-SC message is no longer used to the target base station 240 (S625). Then, the serving base station 230 transmits the existing connection information with the terminal 100 to the target base station 240 (S626).

Then, the target base station 240 transmits the handover ranging response to the terminal 100 using the RNG_RSP message (S627). The transmitting and receiving the data using the secondary carrier SC1 between the terminal 100 and the serving base station 230 (S618) is completely terminated according to the RNG_RSP message. Therefore, the MOB_MCHO_COMPLETE message shown in FIG. 4 is omitted.

Thereafter, the terminal 100 transmits the bandwidth request to the target base station 240 through the bandwidth request (BW_REQ) message (S628). The serving base station 230 and the target base station 240 optimize the route and reset it (S629). Thereafter, the terminal 100 terminates the handover process to the target base station 240 to transmit and receive data to and from the target base station 240 (S630).

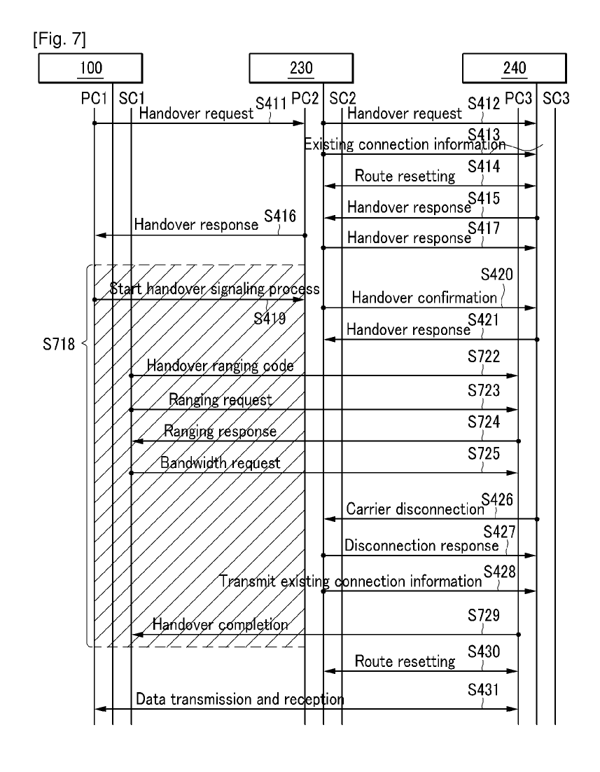

Hereinafter, the method for handover according to another embodiment of the present invention will be described in detail with reference to FIG. 7.

FIG. 7 is a flowchart showing a method for handover according to another embodiment of the present invention.

The method for handover of FIG. 7, the step from the handover request to the serving base station 230 of the terminal 100 (S411) to the handover response to the target base station 240 of the terminal 100 (S421) is the same as the method for handover of FIG. 4.

However, unlike the method for handover of FIG. 4, in the method for handover of FIG. 7, the terminal 100 transmits and receives data to and from the serving base station 230 using only the primary carrier PC1 when the terminal 100 receives the response that the handover can be performed using the multi-carrier through the MOB_BSHO_REQ message from the serving base station 230 (S718).

Further, the terminal 100 uses the secondary carrier SC1 when the terminal 100 transmits a handover ranging code (S711) and transmits a ranging request (S712) and a bandwidth request (S725) to the target base station 240, and the terminal 100 receives a ranging response (S724) from the target base station 240. That is, the terminal 100 performs the handover signaling process using the secondary carrier SC1 and not the primary carrier PC1.

In the handover method of FIG. 7, the subsequent processes are the same as the method for handover of FIG. 4.

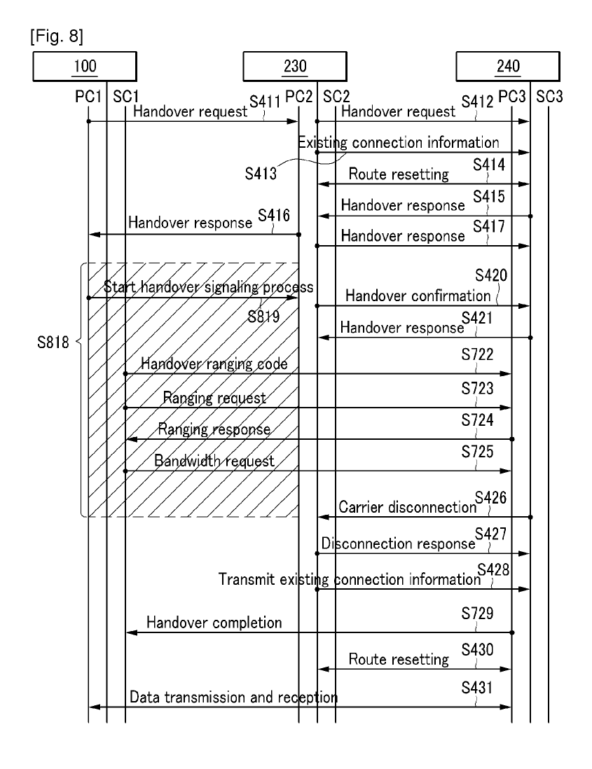

A method for handover according to another embodiment of the present invention will be described with reference to FIG. 8.

FIG. 8 is a flowchart showing a method for handover according to another embodiment of the present invention.

The method for handover of FIG. 8 performs the same process as the method for handover of FIG. 7. However, unlike the method for handover of FIG. 7, in the method for handover of FIG. 8, the transmitting and receiving the data between the terminal 100 and the serving base station 230 using only the primary carrier PC1 (S818) is terminated by the HO-Disconnect-SC message for carrier disconnection (S426). That is, unlike FIG. 7 in which the transmitting and receiving the data between the terminal 100 and the serving base station 230 is terminated by the MOB_MCHO_COMPLETE message, it is terminated by the HO-Disconnect-SC message for the carrier disconnection (S426).

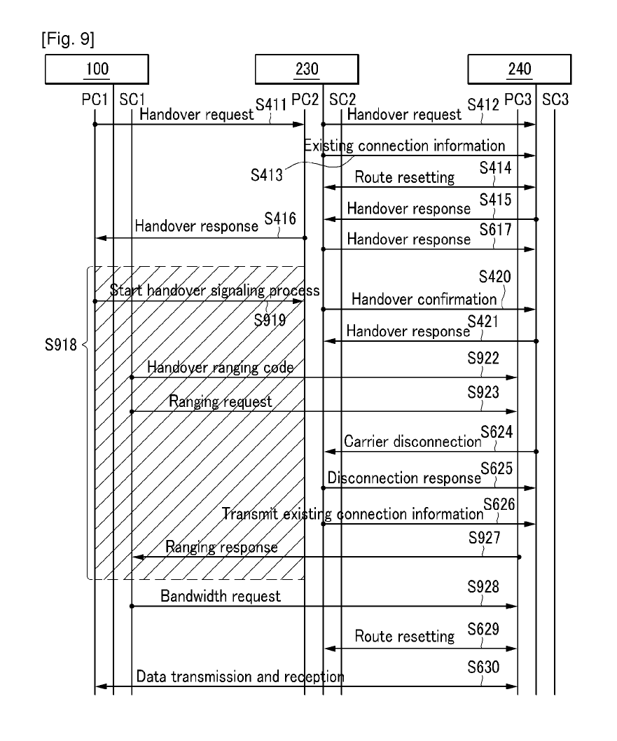

Hereinafter, a method for handover according to another embodiment of the present invention will be described with reference to FIG. 9.

FIG. 9 is a flowchart showing a method for handover according to another embodiment of the present invention.

In the method for handover of FIG. 9, the step from the handover request to the serving base station 230 of the terminal 100 (S411) to the handover affirmation to the target base station 240 of the terminal 100 (S421) is the same as the method for handover of FIG. 6.

However, unlike the method for handover of FIG. 6, the method for handover of FIG. 9 allows the terminal 100 to transmit and receive data to and from the serving base station 230 using only the primary carrier PC1 when the terminal 100 receives the response that the handover can be performed using the multi-carrier through the MOB_BSHO_REQ message from the serving base station 230 (S918).

Further, the terminal 100 uses the secondary carrier SCI when the terminal 100 transmits a handover ranging code (S922), and transmits a ranging request (S923) and a bandwidth request (S928) to the target base station 240, and the terminal 100 receives a ranging response (S927) from the target base station 240. That is, the terminal 100 performs the handover signaling process using the secondary carrier SC1 and not the primary carrier PC1.

In the handover method of FIG. 9, the subsequent processes are the same as the method for handover of FIG. 6.

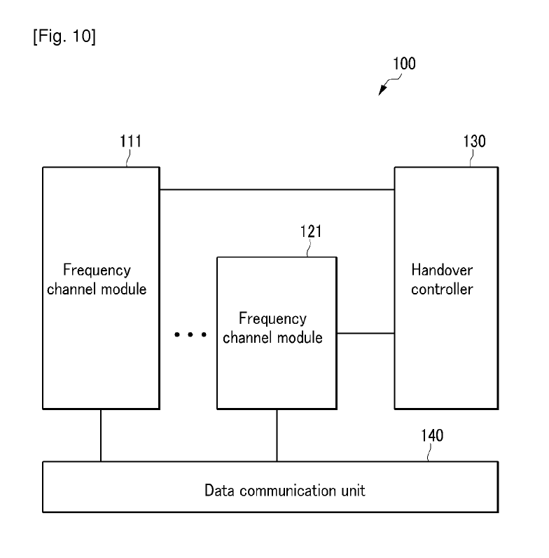

Hereinafter, the terminal according to another embodiment of the present invention will be described in detail with reference to FIG. 10.

FIG. 10 is a block diagram schematically showing a terminal according to another embodiment of the present invention.

Referring to FIG. 10, the terminal 100 according to the present invention includes frequency channel modules 111 and 121, a handover controller 130, and a data communication unit 140.

Each of the frequency channel modules 111 and 121 supports the multi-carrier. A carrier supported by any one of a plurality of frequency channel modules 111 and 121 may be used as the primary carrier, and a carrier supported by the remaining frequency channel module may be used as the secondary carrier, Actually, the frequency channel modules 111 and 121 are included in a physical (PHY) layer.

The handover controller 130 performs the handover by transmitting and receiving the handover related message between the serving base station 230 and the target base station 240. Herein, a handover related message is classified into a message querying whether the handover can be performed and a handover signaling process message. The message querying whether the handover can be performed includes the MOB_MSHO_REQ and the MOBSHO_REQ, and the handover signaling process message includes the HO ranging code, the RNG_REQ, the RNG_RSP, and the BW_REQ. The handover controller 130 transmits and receives the message querying whether the handover can be performed using the primary carrier, and transmits and receives the handover signaling process message using the primary carrier or the secondary carrier.

The data communication unit 140 transmits and receives data to and from the serving base station 230 or the target base station 240. When the handover controller 130 transmits and receives the handover signaling message to and from the target base station 240 using the primary carrier, the data communication unit 140 transmits and receives data to and from the serving base station 230 using the secondary carrier. When the handover controller 130 transmits and receives the handover signaling message to and from the target base station 240 using the secondary carrier, the data communication unit 140 transmits and receives data to and from the serving base station 230 using the primary carrier. Thereafter, the handover process is completed, the data communication unit 140 transmits and receives data to and from the target base station 240 using the primary carrier or the secondary carrier.

The above-mentioned exemplary embodiments of the present invention are not embodied only by an apparatus and method. Alternatively, the above-mentioned exemplary embodiments may be embodied by a program performing functions that correspond to the configuration of the exemplary embodiments of the present invention, or a recording medium on which the program is recorded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method for handover of a terminal supporting a multi-carrier comprising a first carrier and a second carrier, comprising:
transmitting a handover request message to a serving base station;
receiving a handover response message from the serving base station according to a handover response message transmitted from a target base station to the serving base station;
after receiving the handover response message from the serving base station, transmitting and receiving data to and from the serving base station using the first carrier; and
performing a handover signaling process to the target base station using the second carrier.

2. The method for handover of a terminal of claim 1, wherein
the first carrier is a secondary carrier and the second carrier is a primary carrier.

3. The method for handover of a terminal of claim 2, wherein
the transmitting a handover request message to a serving base station is performed using the primary carrier.

4. The method for handover of a terminal of claim 2, wherein
the first carrier is the primary carrier and the second carrier is the secondary carrier.

5. The method for handover of a terminal of claim 4, wherein
the transmitting a handover request message to a serving base station is performed using the primary carrier.

6. The method for handover of a terminal of claim 1, further comprising receiving a handover completion message from the target base station.

7. The method for handover of a terminal of claim 6, wherein
the transmitting and receiving the data to and from the serving base station using the first carrier is completed when the terminal receives the handover completion message.

8. The method for handover of a terminal of claim 1, further comprising receiving the handover completion message from the target base station.

9. The method for handover of a terminal of claim 8, wherein
the transmitting and receiving the data to and from the serving base station using the first carrier is completed when the terminal receives the handover completion message.

10. The method for handover of a terminal of claim 8, wherein
the transmitting and receiving the data to and from the serving base station using the first carrier is completed when the terminal receives a carrier disconnection message transmitted from the target base station to the serving base station.

11. The method for handover of a terminal of claim 1, wherein
the performing the handover signaling process comprises transmitting a handover ranging code to the target base station, transmitting a ranging request message to the target base station, receiving a ranging response message from the target base station, and transmitting a bandwidth request message to the target base station.

12. The method for handover of a terminal of claim 11, wherein
the communication using the first carrier between the terminal and the serving base station is completed by receiving the bandwidth request message.

13. The method for handover of a terminal of claim 11, wherein,
after transmitting the ranging request message, the serving base station receives the carrier disconnection message from the target base station prior to receiving the ranging response message, and
the transmitting and receiving the data to and from the serving base station using the first carrier is completed when the terminal receives the ranging response message.

14. The method for handover of a terminal of claim 13, wherein
the communication using the first carrier between the terminal and the serving base station is completed by transmitting the ranging request message.

15. A terminal comprising:
a first frequency channel module supporting a first carrier;
a second frequency channel module supporting a second carrier;
a handover controller that performs a handover signaling process to a target base station using the first carrier; and
a data communication unit that transmits/receives data to and from the serving base station using the second carrier while the handover signaling process is performed.

16. The terminal of claim 15, wherein
either one of the first carrier and the second carrier is a primary carrier and the other is a secondary carrier.

17. The terminal of claim 16, wherein
the handover controller transmits/receives messages, which query whether or not the handover can be performed, with the serving base station using the primary carrier.
